(19) United States
(12) Patent Application Publication
(10) Pub. No.: US 2010/0090908 A1
(43) Pub. Date: Apr. 15, 2010

(54) ANTENNA OF PARALLEL-RING TYPE

(76) Inventors: Byung Hoon Ryou, Seoul (KR); Won Mo Sung, Gyeonggi-do (KR); Hoe Seok Joeng, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/446,963

(22) PCT Filed: Nov. 23, 2007
(86) PCT No.: PCT/KR2007/005931

§ 371 Date: Oct. 7, 2009

(30) Foreign Application Priority Data
Nov. 23, 2006 (KR) 10-2006-01164557

(51) Int. Cl. H01Q 9/30; H01Q 1/24

(52) U.S. Cl. 343/702; 343/900

(57) ABSTRACT

The present invention relates to a parallel-ring type antenna which is reduced in entire physical length, and has a wider bandwidth and a more excellent return loss, while having the same resonant point, by changing a loading portion of a retractable antenna employing a top-loading method that can easily secure the physical length of the antenna. Further, characteristics electrically similar to those of a helical antenna can be achieved by applying the parallel-ring type to the loading portion of the monopole termination. In addition, the entire length of an antenna can be reduced, while accomplishing the same resonance as that of the helical antenna, by employing a change in return loss according to a change in the thickness of the parallel ring, the distance between the rings, the diameter of the ring, and/or the length of the loading portion.

### TECHNICAL FIELD

The present invention relates to a parallel-ring type antenna, and more particularly, to an antenna which is reduced in entire physical length, and has a wider bandwidth and a more excellent return loss, while having the same resonant point, by changing a loading portion of a retractable antenna employing a top-loading method that can easily secure the physical length of the antenna.

### BACKGROUND ART

Digital television (DTV) is television which converts a received broadcasting signal into a digital format so as to be added with various functions such as reproduction of a screen with a high picture quality and the like. DTV is so-called a third-generation television system which was developed after white-and black television and color television. This DTV includes an additional integrated circuit (IC) to which a variety of functions can be added and converts an analog signal, transmitted from a broadcasting station, into a digital signal. Thus, degradation of video and audio signals can be prevented and the video and audio signals can be restored accurately, so that there are no dual screens occurring due to the return of analog radio waves and no noise occurs.

DTV has 1,050 television scan lines and has a sharper screen accordingly. A multi-screen can be configured using the broadcasting signal storage and processing functions of DTV. Thus, DTV have a variety of functions, such as that screens transmitted from two or three broadcasting companies can be viewed on one television screen, that an instant behavior in a screen can be stopped and enlarged, and that a stored behavior can be confirmed and printed through a printer.

In recent years, the technology of DTV has been developed and the demand for DTV has increased rapidly. This represents the worldwide cultural and technical aspects. In line with this trend, people want to utilize images and/or sound of a high quality, that is, a multimedia service, while driving or walking. Digital Video Broadcasting-Handheld (DVB-H) is the technology standard enacted to improve the reception rate of terrestrial DTV while moving in Europe and enables mobile reception by improving the performance of a Digital Video Broadcasting-Terrestrial (DVB-T) system.

In mobile communication terminals, a top-loading type retractable antenna has been widely used that can easily secure the physical length of the antenna in order to satisfy a relatively low frequency band ranging from 472 to 742 MHz of the DVB-H antenna.

FIG. 1 shows an example of a conventional retractable antenna. An antenna 100 has a structure in which a helical antenna 101 is coupled to a loading portion of the monopole. A dielectric material having a dielectric constant of 3.5 is inserted into a central portion of the antenna in order to fix the helical antenna. Reference numeral 110 shows an enlargement of the helical (101) portion of the helical antenna.

However, the helical antenna is a kind of a spiral antenna and is a progressive wave antenna whose main beam is varied at right angles to the spiral axis when the length of one spiral winding is far smaller than a wavelength and is varied in the axial direction when the length thereof is about one wavelength in an antenna element made of a spiral conductive line. Accordingly, the conventional helical antenna is problematic in that it has a complicated structure and is difficult to maintain the electrical stability of its connector since the helical antenna 101 must be connected to the monopole antenna. The conventional helical antenna is also problematic in that it has a narrow bandwidth and poor radiation efficiency, and the helical connector is easily broken.

### DISCLOSURE

### Technical Problem

Accordingly, the present invention has been made in view of the above problems occurring in the prior art, and an object of the present invention is to propose a new technology regarding a parallel-ring type antenna.

Another object of the present invention is to achieve characteristics similar to those of the helical antenna in terms of electricity by applying the parallel-ring type to a loading portion of a monopole termination based on the property that current flows on the surface of a conductor.

Still another object of the present invention is to reduce the entire length of the antenna, while achieving the same resonance as that of the helical antenna, by employing a change in return loss according to a change in the thickness of the parallel-ring, a distance between rings or the diameter of a ring, or a change in the length of the loading portion.

Still another object of the present invention is to design an antenna, which is more stable electrically and structurally and has a higher gain and a wider bandwidth, using a length shorter than that of the helical antenna.

### Technical Solution

To achieve the above objects and solve the above problems occurring in the prior art, an antenna of a mobile communication terminal according to an embodiment of the present invention includes a loading portion having a parallel-ring type.

In accordance with an aspect of the present invention, the parallel-ring type may include the rings and a central conductor. Return loss of the antenna may be changed according to a first thickness and a first diameter of the ring, a distance between the rings, and a second diameter of the central conductor.

In accordance with another aspect of the present invention, the antenna may further include a monopole antenna. The central conductor may be coupled to one end of the monopole antenna.

In accordance with still another aspect of the present invention, the antenna may further include a monopole antenna. The loading portion may be coupled to one end of the monopole antenna.

### Advantageous Effects

As described above, according to the present invention, characteristics electrically similar to those of the helical antenna can be achieved by applying the parallel-ring type to the loading portion of the monopole termination based on the property that current flows on the surface of a conductor.

Further, according to the present invention, the entire length of an antenna can be reduced, while accomplishing the same resonance as that of the helical antenna, by employing a change in return loss according to a change in the thickness of the parallel rings, the distance between the rings, the diameter of each of the rings, and/or the length of the loading portion.

In addition, according to the present invention, an antenna, which is more stable electrically and structurally physically and has a higher gain and a wider bandwidth, can be designed using a length shorter than that of the helical antenna.

### DESCRIPTION OF DRAWINGS

Further objects and advantages of the invention can be more fully understood from the following detailed description taken in conjunction with the accompanying drawings in which:

FIG. 1 shows an example of a conventional retractable antenna;

FIG. 2 is a view illustrating the structure of a parallel-ring type antenna according to an embodiment of the present invention;

FIG. 3 shows an example of a parallel-ring type antenna structure;

FIG. 4 shows an example of a change in return loss according to a change in the thickness of a ring;

FIG. 5 shows an example of a change in return loss according to a change in the distance between rings;

FIG. 6 shows an example of a change in return loss according to a change in the diameter of a central conductor;

FIG. 7 shows an example of a change in return loss according to a change in the diameter of a ring;

FIG. 8 shows an example of a change in return loss according to a change in the length of a loading portion;

FIG. 9 shows an example of comparison between return loss of the conventional helical antenna and return loss of the antenna according to an embodiment of the present invention through the simulation results;

FIG. 10 shows an example of an antenna fabricated according to optimal design conditions;

FIG. 11 shows an example of comparison between return loss of the antenna according to an embodiment of the present invention and return loss of the conventional helical antenna;

FIG. 12 shows an example of the antenna mounted in a mobile communication terminal according to an embodiment of the present invention; and

FIG. 13 shows an example of comparison between return loss of the antenna mounted in a mobile communication terminal according to an embodiment of the present invention and return loss of the conventional helical antenna.

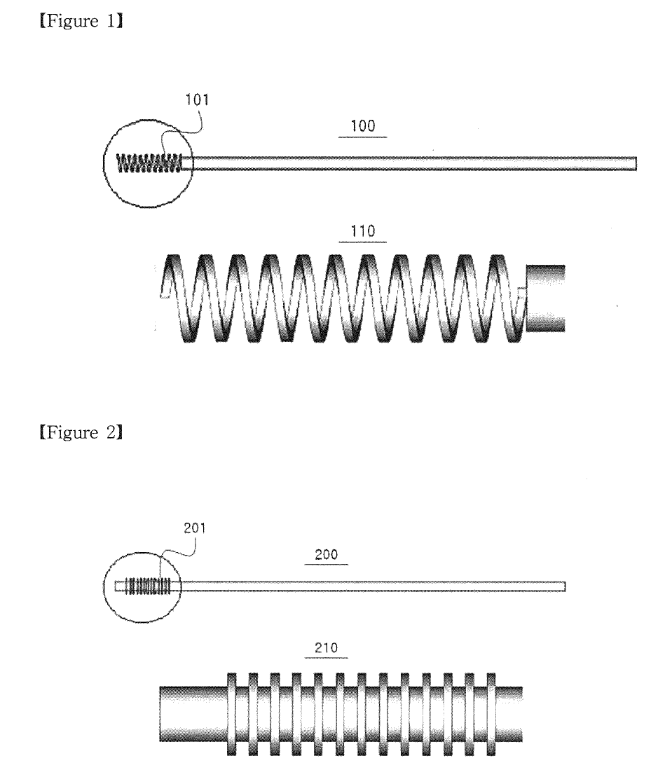

### BEST MODE

The present invention will now be described in detail in connection with specific embodiments with reference to the accompanying drawings.

As defined herein, the term “mobile communication terminal” refers to portable electrical and electronic devices including all kinds of handheld-based radio communication devices, such as portable devices that may include a communication function such as Personal Digital Cellular (PDS) phones, Personal Communication Service (PCS) phones, Personal Handyphone System (PHS) phones, CDMA-2000 (1X, 3X) phones, Wideband Code Division Multiplexing Access (WCDMA) phones, dual band/dual mode phones, Global Standard for Mobile (GSM) phones, Mobile Broadband System (MBS) phones, Digital Multimedia Broadcasting (DMB) phones, smart phones, and hand phones, portable terminals such as Personal Digital Assistant (PDA), hand-held PC, notebook computer, laptop computer, WiBro terminal, MP3 player, and MD player, and International Mobile Telecommunication-2000 (IMT-2000) terminals that provide the international roaming service and expanded mobile communication services. The mobile communication terminal is interpreted as a concept generally referring to a terminal, which can be equipped with a CDMA module, a Bluetooth module, an infrared data association module, a wired/wireless LAN card, or a communication module, such as a radio communication device having a Global Positioning System (GPS) chip mounted therein in order to enable position tracking through GPS, and can perform a specific calculation operation by having mounted therein a microprocessor that is able to perform a multimedia play function. The present invention relates to a parallel-ring type antenna in which a ring is arranged in a monopole termination based on the property that current flows on the surface of a conductor.

FIG. 2 is a view illustrating the structure of a parallel-ring type antenna according to an embodiment of the present invention.

An antenna 200 includes a loading portion 201 having a parallel-ring structure. Reference numeral 210 denotes the loading portion 201 which is enlarged. A number of rings are arranged at the loading portion of the monopole antenna. That is, several rings are arranged in parallel on the outer circumference of a cylindrical central conductor coupled to the monopole antenna. This antenna 200 may include a DVB-H antenna based on a mobile communication terminal that supports a low frequency band of 800 MHz. By simply extending and forming a part of the monopole antenna or forming the parallel rings on the outer circumference of the central conductor that can make a surface contact with the monopole antenna at least without coupling an additional helical antenna as described above, problems such as degradation of an antenna characteristic and weakness of mechanical strength due to the instability of a contact can be solved.

The loading portion may have a resonant point closer to a low frequency and an overall reduced physical length for the same resonant point as the length thereof is increased. Return loss may also be changed according to a first thickness and/or a first diameter of the ring, a distance between the rings, and/or a second diameter of the ring.

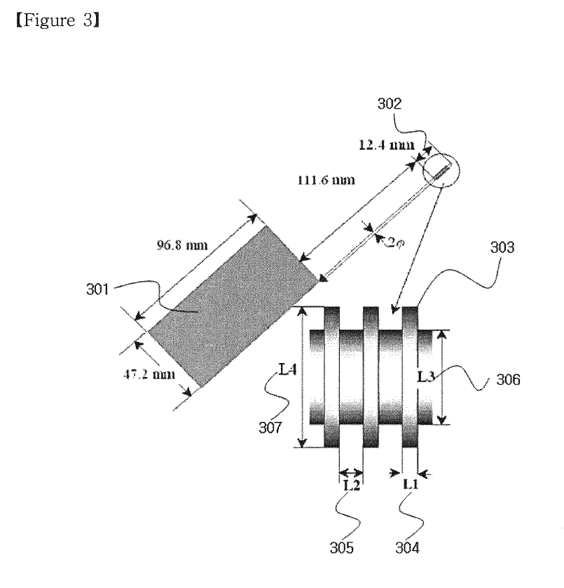

FIG. 3 shows an example of a parallel-ring type antenna structure.

In the example of FIG. 3, an antenna radiator and a ground 301 may be made of a fully conductive material. The ground 301 may have 96.8 mm, 47.2 mm and 1 mm in width, length and height, respectively, and can be set on the basis of an actual size of a mobile communication terminal. Further, a design frequency may be set in the range of DVB-H 472 MHz to 742 MHz on the basis of a mobile communication terminal model that supports a low frequency band of 800 MHz.

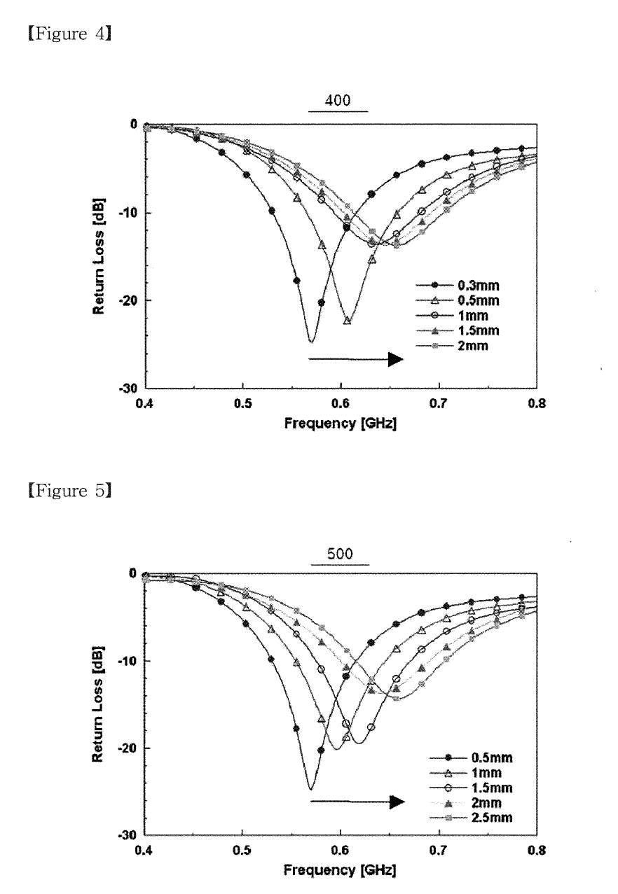

A length 302 of the loading portion 303 of the antenna may be set to 12.4 mm. Reference numeral 303 refers to an enlargement of the loading portion. L1 304 designates the thickness of the ring, L2 305 designates the distance between the rings, L3 306 designates the diameter of the central conductor, and L4 307 designates the diameter of the ring. As described above, a change in the length 302, L1 304, L2 305, L3 306 or L4 307 of the loading portion causes a change in return loss. This is described in detail below with reference to the simulation results of FIGS. 4 to 8.

FIG. 4 shows an example of a change in return loss according to a change in the thickness of a ring. As shown in FIG. 4 a graph 400 illustrates return loss according to the frequency when parameters, indicating the thickness L1 of the ring, are 0.3 mm, 0.5 mm, 1 mm, 1.5 mm and 2 mm. From the graph 400, it can be seen that as the thickness L1 is increased from 0.3 mm to 2 mm, the resonant point is shifted toward a high frequency. This is caused by a phenomenon in which the electrical length of the antenna is shortened as the thickness of the ring is increased in a state where the length of the loading portion is fixed.

FIG. 5 shows an example of a change in return loss according to a change in the distance between the rings. As shown in FIG. 5, a graph 500 illustrates return loss according to the frequency when parameters, indicating the distance between the rings, are 0.5 mm, 1 mm, 1.5 mm, 2 mm and 2.5 mm.

From the graph 500, it can be seen that as the distance L2 is increased from 0.5 mm to 2.5 mm, the resonant point is shifted toward a high frequency. This is caused by a phenomenon in which the entire electrical length of the antenna is shortened as the distance between the rings is increased.

From FIGS. 4 and 5, it can be seen that as the thickness of the ring and the distance between the rings are increased with the length of the loading portion being fixed, the electrical length of the antenna is shortened. It can be seen that the length of the loading portion, that is, the physical size of the loading portion can be shrunk using the same.

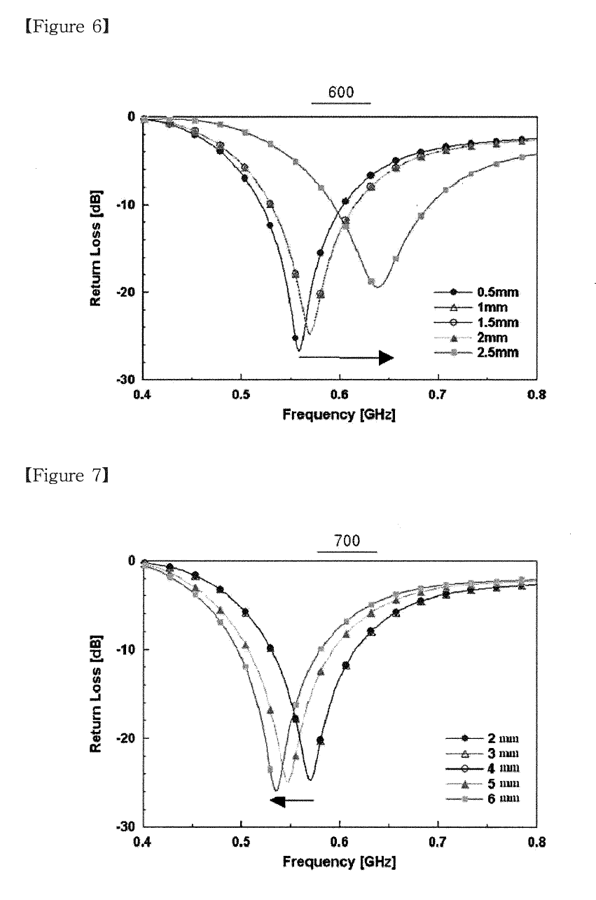

FIG. 6 shows an example of a change in return loss according to a change in the diameter of the central conductor. As shown in FIG. 6 a graph 600 illustrates return loss according to the frequency when parameters, indicating the diameter L3 of the central conductor, are 0.5 mm, 1 mm, 1.5 mm, 2 mm and 2.5 mm.

From the graph 600, it can be seen that as the diameter L3 of the central conductor is increased from 0.5 mm to 2.5 mm, the resonant point is shifted toward a high frequency. This is caused by a phenomenon in which the electrical length of the antenna is shortened as an effective diameter of the ring is reduced as the diameter of the central conductor is increased.

FIG. 7 shows an example of a change in return loss according to a change in the diameter of the ring. As shown in FIG. 7, a graph 700 illustrates return loss according to the frequency when parameters, indicating the diameter IA of the ring, are 2 mm, 3 mm, 4 mm, 5 mm and 6 mm.

From the graph 700, it can be seen that as the diameter IA of the ring is increased from 2 mm to 6 mm, the resonant point is shifted toward a low frequency. This is caused by a phenomenon in which the electrical length of the antenna is lengthened as the diameter of the ring is increased.

From FIGS. 6 and 7, it can be seen that the electrical length of the antenna is lengthened or shortened according to a change in the diameter of the ring and the central conductor. The length of the loading portion can be reduced while obtaining the same antenna characteristic using the same.

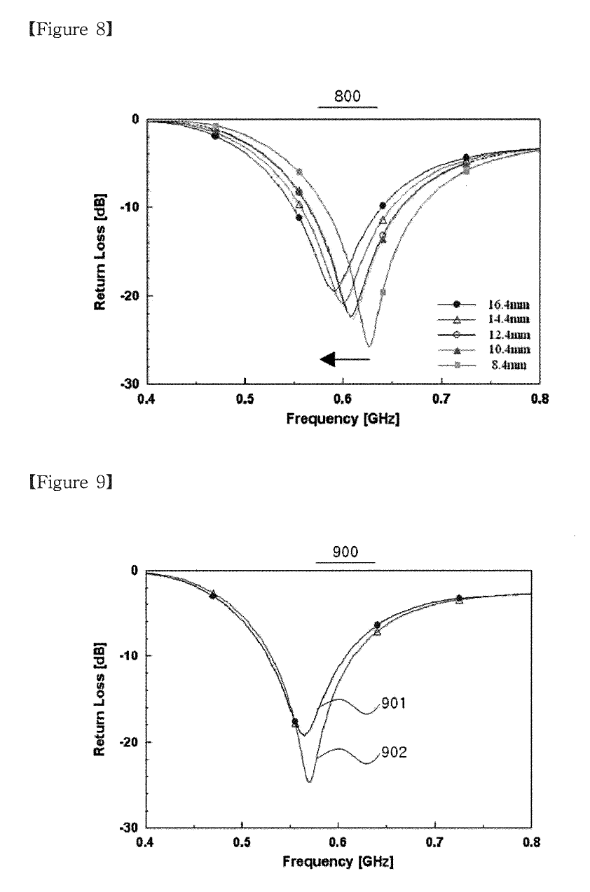

FIG. 8 shows an example of a change in return loss according to a change in the length of the loading portion. As shown in FIG. 8, a graph 800 illustrates return loss according to the frequency when parameters, indicating the length of the loading portion, are 16.4 mm, 14.4 mm, 12.4 mm, 10.4 mm and 8.4 mm. From the graph 800, it can be seen that the resonant point is shifted toward a low frequency as the length of the loading portion is increased from 8.4 mm to 16.4 mm.

As described above, if the length of the parallel-ring portion is increased, the electrical length of the antenna is increased. Thus, there is an effect in that the entire physical length of the antenna can be reduced for the purpose of the same resonant point.

FIG. 9 shows an example of comparison between return loss of the conventional helical antenna and return loss of the antenna according to an embodiment of the present invention through the simulation results.

The parallel-ring type antenna is an antenna according to optimal design conditions which were obtained through the simulation results of FIGS. 4 to 8. The design conditions are listed in Table 1.

TABLE 1
specifiaction

| | | |
|---|---|---|
| Loading Length | 12.4 | mm |
| L1 | 0.3 | mm |
| L2 | 0.5 | mm |
| L3 | 2 | Φ |
| L4 | 3 | Φ |
| Toral Length | 124 | mm |
| Monopole Length | 111.6 | mm |

As shown in FIG. 9, a graph 900 illustrates the simulation results of return loss 901 with respect to the frequency of the helical antenna and return loss 902 with respect to the frequency of the antenna. From this graph, it can be seen that the antenna has a wider bandwidth and excellent return loss when compared with the helical antenna.

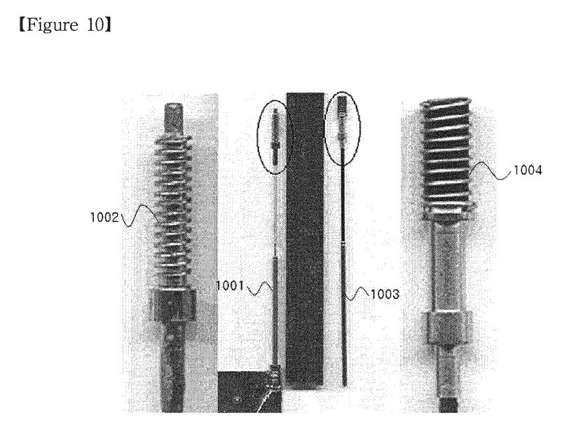

FIG. 10 shows an example of an antenna fabricated according to optimal design conditions.

Reference numerals 1001 and 1002 designate an antenna, which was fabricated by employing the parallel ring according to the optimal design conditions, and an enlargement of the loading portion of the parallel ring type antenna, respectively.

Reference numerals 1003 and 1004 designate the conventional helical antenna and an enlargement of the loading portion of the helical antenna.

The antenna and the helical antenna were fabricated to have the same resonant point, but the length of the antenna was shorter 4 mm than that of the helical antenna. As described above, the antenna is advantageous in that it can have a reduced length while having the same resonant point as that of the helical antenna.

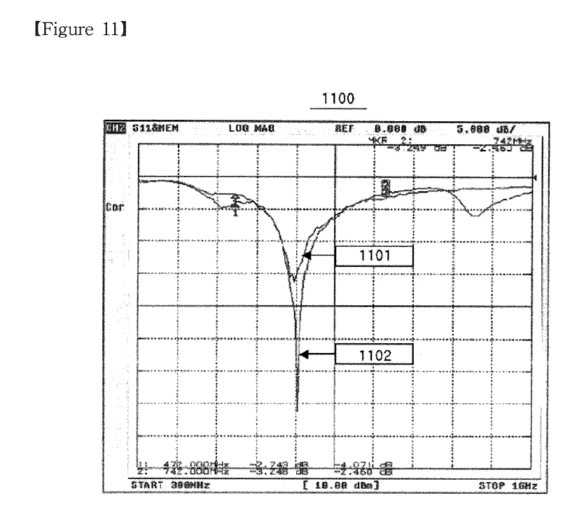

FIG. 11 shows an example of comparison between return loss of the antenna according to an embodiment of the present invention and return loss of the conventional helical antenna.

A graph 1100 illustrates return loss of the antenna of the present invention and return loss of the conventional helical antenna. When comparing return loss 1101 of the helical antenna and return loss 1102 of the antenna of the present invention, it can be seen that the antenna of the present invention can have not only a wider bandwidth, but also excellent return loss as in the simulation results of FIG. 9.

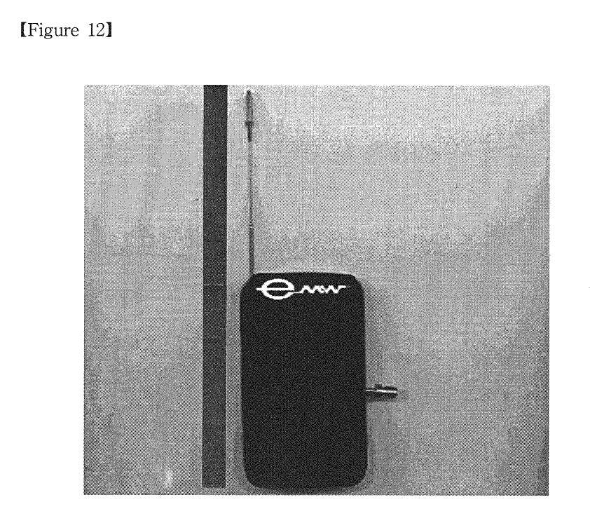

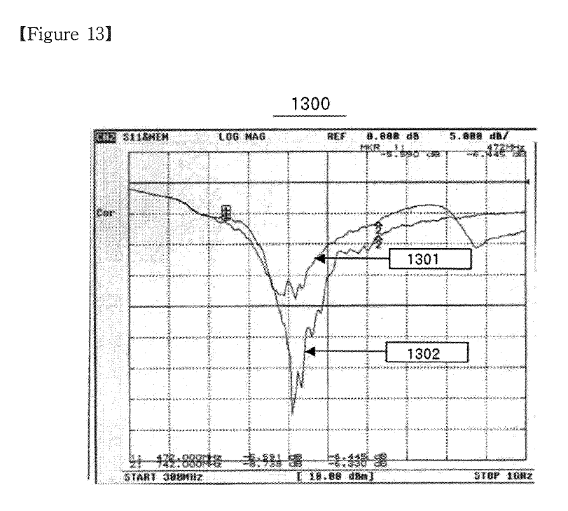

FIG. 12 shows an example of the antenna mounted in a mobile communication terminal according to an embodiment of the present invention. FIG. 13 shows an example of comparison between return loss of the antenna mounted in a mobile communication terminal according to an embodiment of the present invention and return loss of the conventional helical antenna.

As shown in FIG. 12, the antenna fabricated by employing the parallel-ring type was mounted in an actual mobile communication terminal and return loss thereof was measured. Comparison results of return loss 1301 of the helical antenna and return loss 1302 of the antenna which was mounted in the mobile communication terminal are shown in a graph 1300 of FIG. 13. From the comparison results, it can be seen that the antenna of the present invention has a wider bandwidth and excellent return loss as described above with reference to FIGS. 9 and 11.

The following Tables 2 and 3 list maximum gains and average gains of the monopole antenna, the helical antenna, and the antenna according to an embodiment of the present invention, which were tested and measured in a non-reflection room.

TABLE 2
Maximum Gain

| Freq. [MHz] | Monopole | Helix | Parallel Ring |
|---|---|---|---|
| 472 | 4.41 | 4.37 | 4.19 |
| 490 | 5.23 | 4.96 | 4.75 |
| 506 | 4.38 | 4.25 | 4.37 |
| 546 | 3.60 | 3.33 | 3.04 |
| 586 | 2.08 | 2.04 | 2.07 |
| 626 | 2.86 | 2.63 | 2.90 |
| 666 | 3.45 | 3.01 | 3.42 |
| 706 | 3.70 | 2.73 | 3.10 |
| 742 | 3.88 | 2.10 | 3.54 |

TABLE 3
Average Gain

| Freq. [MHz] | Monopole | Helix | Parallel Ring |
|---|---|---|---|
| 472 | −1.31 | −1.58 | −1.59 |
| 490 | −0.73 | −0.78 | −1.10 |
| 506 | −1.04 | −1.43 | −1.81 |
| 546 | −1.40 | −1.57 | −1.76 |
| 586 | −2.10 | −2.27 | −2.02 |
| 626 | −1.81 | −2.10 | −1.75 |
| 666 | −0.80 | −1.44 | −0.83 |
| 706 | −1.76 | −2.71 | −1.92 |
| 742 | −1.45 | −2.76 | −1.49 |

From Tables 2 and 3, it can be seen that the antenna according to an embodiment of the present invention has characteristics, which are equivalent to or better than those of the conventional helical antenna in terms of the average gain and the maximum gain, although it has the entire length of 4 mm, which is smaller than that of the helical antenna, and also has characteristics similar to those of the monopole antenna than the helical antenna. In addition, the antenna according to an embodiment of the present invention has a radiation pattern similar to that of the helical antenna.

In other words, the antenna, including the monopole in which the loading portion according to an embodiment of the present invention has the parallel-ring type, has a stable characteristic electrically and structurally, a high gain of 0.21 dBi in the maximum gain and 0.26 dBi in the average gain on the average using a length shorter than that of the conventional helical antenna, and a wide bandwidth of about 70 MHz in return loss on the basis of the standing-wave ratio 2:1 of −10 dB or less.

As described above, the present invention can achieve characteristics electrically similar to those of the helical antenna by applying the parallel-ring type to the loading portion of the monopole termination based on the property that current flows on the surface of a conductor.

Further, the entire length of an antenna can be reduced, while accomplishing the same resonance as that of the helical antenna, by employing a change in return loss according to a change in the thickness of the parallel ring, the distance between the rings, the diameter of the ring, and/or the length of the loading portion. An antenna, which is further stable electrically and structurally and has a higher gain and a wider bandwidth, can also be designed using a length shorter than that of the helical antenna.

Accordingly, when the antenna of the present invention is employed as the DVB-H antenna, an antenna, which has a short length physically and can receive broadcasting with an excellent picture quality when compared with the prior art, can be fabricated.

Although the specific embodiments of the present invention have been disclosed for illustrative purposes, those skilled in the art will appreciate that various modifications, additions and substitutions are possible, without departing from the scope and spirit of the invention as disclosed in the accompanying claims.

1. An antenna of a mobile communication terminal, which comprises a loading portion having a parallel-ring structure.

2. The antenna of claim 1, wherein the parallel-ring structure comprises rings and a central conductor, wherein return loss of the antenna is changed according to a first thickness and a first diameter of each of the rings, a distance between the rings, and a second diameter of the central conductor.

3. The antenna of claim 2, further comprising a monopole antenna, wherein the central conductor is coupled to one end of the monopole antenna.

4. The antenna of claim 1, further comprising a monopole antenna, wherein the loading portion is coupled to one end of the monopole antenna.

5. The antenna of claim 4, wherein the monopole antenna is a retractable antenna that is inserted into or extracted from the mobile communication terminal.

6. A mobile communication terminal comprising an antenna according to claim 1.
